(19) United States
(12) Patent Application Publication
(10) Pub. No.: US 2026/0340170 A1
(43) Pub. Date: Oct. 29, 2026

(54) ENTRY PAGES FOR ELECTRONIC DOCUMENTS

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/638,039

(22) Filed: Apr. 2, 2026

Related U.S. Application Data
(63) Continuation of application No. PCT/US2025/033986, filed on Jun. 17, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 21/62; G06F 16/93; G06F 21/60; G06F 40/103

(52) U.S. Cl. CPC G06F 21/6218; G06F 16/93; G06F 21/602; G06F 40/103

(57) ABSTRACT

A device may receive, at an electronic document executing on a physical processor, a request from a link to the electronic document. A device may process, by the electronic document, the request. A device may respond, by the electronic document, to the request by providing access to data of the electronic document.

### PRIORITY CLAIMS TO RELATED APPLICATIONS

This application is a continuation application of and claims priority to International Patent Application No. PCT/US25/33986 filed Jun. 17, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

Electronic documents have become the cornerstone of modern workflows, enabling the storage, sharing, and management of information across industries. However, despite their widespread adoption, traditional electronic documents remain constrained by the limitations of their design, which mirrors the static nature of physical documents. Formats such as PDFs, Word files, and spreadsheets are often rigid and unresponsive, functioning as standalone files that lack adaptability, interactivity, and contextual awareness. Once distributed, these documents are difficult to control, as they are frequently copied, downloaded, and stored in multiple locations, leading to challenges in version control, access management, and data security. Furthermore, traditional electronic documents do not possess mechanisms to dynamically adjust their content or functionality based on the user, environment, or workflow, leaving organizations reliant on external policies and legal frameworks to manage document security and compliance. These limitations are particularly problematic in environments where sensitive information must be protected or where different users require tailored access to specific sections of a document. As workflows become increasingly complex and collaborative, there is a pressing need for a new paradigm that moves beyond the static nature of traditional electronic documents to enable dynamic, interactive, and secure document management.

### SUMMARY

In some aspects, the techniques described herein relate to a method including: receiving, at an electronic document executing on a physical processor, a request from a link to the electronic document; processing, by the electronic document, the request; responding, by the electronic document, to the request by providing access to data of the electronic document.

In some aspects, the techniques described herein relate to a system including: at least one physical processor; physical memory including computer-executable instructions that, when executed by the physical processor, cause the physical processor to: receive, at an electronic document executing on a physical processor, a request from a link to the electronic document; process, by the electronic document, the request; respond, by the electronic document, to the request by providing access to data of the electronic document.

In some aspects, the techniques described herein relate to a non-transitory computer-readable medium including computer-executable instructions that, when executed by at least one of one or more processors of a computing device, cause the computing device to: receive, at an electronic document executing on a physical processor, a request from a link to the electronic document; process, by the electronic document, the request; respond, by the electronic document, to the request by providing access to data of the electronic document.

These and other features will be more clearly understood from the following detailed description taken in conjunction with the accompanying drawings and claims.

### BRIEF DESCRIPTION OF THE DRAWINGS

FIG. 1 depicts the internal structure of a document as a smart digital object, highlighting its embedded interfaces, including storage, access control, and processing instructions, which interact with data storage and a physical processor to enable secure and dynamic document management.

FIG. 2 presents a system architecture where the document is stored on a server connected to a network, allowing interaction with computing devices equipped with a physical processor, memory, and a viewer for rendering and managing the document.

FIG. 3 outlines a method for processing access requests to the document, including receiving a request, processing it, and responding by providing access to the document's data.

FIG. 4 details a method for revoking access rights, handling additional access requests, and denying access to unauthorized entities, ensuring robust control and security over the document's lifecycle.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Traditional electronic documents, such as PDFs, Word files, and spreadsheets, have long mirrored the functionality of physical documents, serving as static carriers of information. This design stems from the early days of digital technology, where the goal was to replicate the familiar experience of handling paper documents in a digital format. As a result, these electronic documents are often rigid and unresponsive, functioning as “digital bricks”—fixed entities that lack adaptability, interactivity, and contextual awareness. While this approach provided simplicity and familiarity, it has also imposed significant limitations, particularly in modern workflows that demand dynamic functionality, seamless collaboration, and secure access. Electronic documents with embedded intelligence offer a transformative solution to these challenges, enabling documents to act as active, context-aware entities accessible via links, which can take the form of entry pages, icons, or other entry points.

The concept of traditional electronic documents as “digital bricks” highlights their static nature. Like physical documents, they are designed to have fixed layouts and content that does not change based on the user or environment. For example, a PDF shared with multiple recipients will display the same content to all viewers, regardless of their roles, security clearances, or specific needs. This rigidity creates inefficiencies and risks, particularly in environments where sensitive information must be protected or where different users require tailored access to specific sections of a document. Furthermore, traditional electronic documents lack the ability to interact with external systems, track their lifecycle, or respond to changes in their environment, leaving organizations reliant on external policies and legal frameworks to manage document security and compliance.

The limitations of traditional electronic documents are further exacerbated by their reliance on static file-based systems. Once distributed, these documents are often copied, downloaded, and stored in multiple locations, creating challenges in version control, access management, and data security. For example, a contract shared via email may be downloaded by multiple parties, resulting in fragmented versions that are difficult to track and synchronize. Similarly, sensitive documents stored on local devices are vulnerable to unauthorized access, theft, or loss, as their security depends on external measures such as passwords or encryption. These issues underscore the need for a new paradigm that moves beyond the static nature of “digital bricks” to enable documents that are dynamic, interactive, and secure.

Electronic documents with embedded intelligence address these challenges by transforming the way documents are accessed, managed, and interacted with. Instead of functioning as standalone files, intelligent documents are accessible via links, which serve as entry points to the document's content and functionality. These links can take various forms, such as cover pages, icons, or scannable codes, providing users with a seamless and intuitive way to access the document. For example, a cover page may act as a gateway to the document, displaying basic information about the file and providing a secure link to its content. Similarly, an icon associated with the document may serve as an entry point, allowing users to open the file directly from their device or cloud storage. Scannable codes, such as QR codes, can also be used as entry points, enabling users to access the document by scanning the code with their mobile device.

The use of links as entry points enhances the functionality and security of electronic documents. By providing access through a link, intelligent documents eliminate the need for multiple copies, ensuring that all users interact with the same version of the file. This approach simplifies version control and reduces the risk of discrepancies, as updates made to the document are automatically reflected for all users. Additionally, links can be configured to enforce access controls, ensuring that only authorized users can view or edit the document. For example, a cover page may require users to authenticate themselves before granting access to the file, while an icon may restrict access based on the user's role or security clearance. These features provide robust security while maintaining flexibility and usability.

Embedded intelligence further enhances the capabilities of electronic documents by enabling them to adapt their behavior based on context. For instance, a contract accessed via a cover page may display different sections to different users, such as revealing confidential clauses to attorneys while presenting a simplified version to clients. Similarly, a marketing brochure accessed via an icon may reformat its layout for mobile devices, ensuring readability on smaller screens. Scannable codes can also provide context-aware functionality, such as linking to localized content based on the user's geolocation. These dynamic features transform electronic documents from static “digital bricks” into active entities that respond to the needs of users and environments.

The integration of links as entry points also facilitates seamless collaboration and interconnectivity. For example, a research paper accessed via a cover page may link to related studies, datasets, or appendices, allowing users to explore supplementary materials directly from the document. Similarly, a project plan accessed via an icon may synchronize changes across multiple users and devices, ensuring that all collaborators are working with the most up-to-date version. Scannable codes can enable real-time sharing, allowing users to access the document instantly by scanning the code with their device. These features enhance workflows and improve efficiency, making intelligent documents a valuable tool for modern digital environments.

Traditional electronic documents mirror the functionality of physical documents, functioning as “digital bricks” that are static, unresponsive, and difficult to manage. While this design provided familiarity and simplicity, it has imposed significant limitations in workflows that demand dynamic functionality, secure access, and seamless collaboration. Electronic documents with embedded intelligence address these challenges by transforming the way documents are accessed and interacted with, using links as entry points to provide centralized, secure, and context-aware functionality. Whether in the form of cover pages, icons, or scannable codes, these entry points enable intelligent documents to act as active entities that adapt to the needs of users and environments, redefining the role of documents in modern digital ecosystems.

A smart electronic document is a transformative innovation in digital information management, designed to autonomously monitor, record, and manage its lifecycle, interactions, and provenance. Unlike traditional documents, which rely on external systems for tracking changes and interactions, smart electronic documents embed intelligence directly within themselves, enabling them to function as active entities. This embedded intelligence allows the document to independently identify events, such as access attempts, modifications, or interactions with other systems, and record these events as part of its metadata. By maintaining a comprehensive audit trail inseparable from the document itself, smart electronic documents ensure transparency, accountability, and security throughout their lifecycle.

Attributes of smart electronic documents address the limitations of traditional document management systems. These documents are uniquely addressable, equipped with permanent identifiers that ensure reliable access and referencing. They maintain version control by creating new, uniquely identifiable versions for any changes, preserving the integrity of the original document while providing a clear record of its evolution. Cryptographic mechanisms validate modifications and tie them to specific versions, ensuring authenticity and preventing unauthorized alterations. By combining embedded intelligence, structured metadata, and robust security features, smart electronic documents redefine document management, offering unparalleled reliability, security, and adaptability.

Entry pages, also can serve as dynamic gateways to the content and functionality of a document, enabling seamless interaction while addressing critical challenges such as backward compatibility, security, and user experience. An entry page is a specialized interface associated with a smart electronic document. It acts as a gateway, providing users with access to the document's content and functionality. Unlike traditional static cover pages, entry pages can be dynamic and interactive, capable of adapting to the user's environment, device, and role. They are designed to address the limitations of legacy document formats, such as PDFs and Word files, by enabling backward compatibility while introducing advanced features inherent to smart electronic documents.

One of the roles of entry pages is ensuring backward compatibility. Smart electronic documents may need to coexist with legacy systems and workflows, which often rely on static formats like PDFs. Entry pages enable this coexistence by allowing smart documents to masquerade as traditional documents when accessed through legacy readers. For example, when a smart document is opened in a legacy PDF reader, the entry page can appear as a static cover page, prompting the user to access the full functionality of the document through a modern viewer or platform. This approach ensures that smart documents can be integrated into existing workflows without disrupting established practices.

As another example, a smart document may include an entry page that displays basic information about the document, such as its title, author, and summary, along with a call-to-action directing the user to open the document in a smart viewer. This mechanism allows organizations to transition to smart documents gradually, leveraging their advanced capabilities while maintaining compatibility with legacy systems.

In some examples, entry pages are not merely static placeholders; they are dynamic entities capable of adapting to various contexts. The inventors discussed several dynamic features of entry pages, including device Adaptability as entry pages can reformat their layout based on the user's device, ensuring optimal readability and usability on desktops, tablets, and mobile phones. Entry pages can tailor their content and functionality based on the user's role or security clearance. For example, a manager accessing a project plan may see administrative controls, while a team member sees task-specific details. Entry pages can provide localized content based on the user's geolocation. For instance, a product catalog accessed in France may default to French language and regional pricing. Entry pages can include interactive elements such as embedded forms, charts, or calculators, allowing users to perform tasks directly within the entry page without opening the full document.

Security can be a cornerstone of entry pages, as they serve as the first point of interaction between the user and the document. For example, entry pages can enforce multi-factor authentication, requiring users to verify their identity through passwords, biometric data, or one-time codes before granting access to the document. Entry pages can restrict access to specific sections of the document based on the user's role or clearance level. For example, a legal contract may allow attorneys to view confidential clauses while limiting clients to a summary. Entry pages can include encrypted elements, ensuring that sensitive information remains secure during transmission and access. Entry pages can log all interactions, creating a robust audit trail that enhances accountability and compliance. In some examples, the entry page acts as a container for the smart document, providing a bridge between the old and new paradigms. For example, a PDF entry page may include a scannable QR code or hyperlink directing the user to the smart document's secure cloud location. Similarly, a JPEG entry page may display a static image with embedded metadata linking to the smart document. This approach ensures that smart documents can be distributed and accessed using legacy systems while retaining their advanced capabilities. The inventors referred to this mechanism as a “Sherpa” for the smart document, guiding users from the legacy format to the modern experience.

Entry pages have a wide range of applications across industries and workflows. The inventors provided several examples to illustrate their versatility. In scenarios where organizations must submit documents to regulatory agencies that only accept legacy formats, entry pages enable the conversion of smart documents into static formats while preserving their connection to the original source. Entry pages can act as interactive gateways for marketing materials, providing localized content, analytics, and call-to-action elements tailored to the target audience. Entry pages can enforce role-based access and authentication for sensitive legal documents, ensuring that only authorized parties can view or edit specific sections. Entry pages can provide dynamic features such as quizzes, annotations, and supplementary resources, enhancing the learning experience for students.

Entry pages can be designed to be lightweight and efficient, ensuring that they can be rendered quickly on legacy systems while providing a seamless transition to the smart document experience. They can include visible and invisible machine-readable codes, such as QR codes and metadata, to facilitate interaction with external systems and applications. Entry pages can leverage artificial intelligence to provide personalized recommendations, automate workflows, and enhance user interactions.

Overall, entry pages can play a key role in the evolution of smart electronic documents, addressing critical challenges such as backward compatibility, security, and user experience.

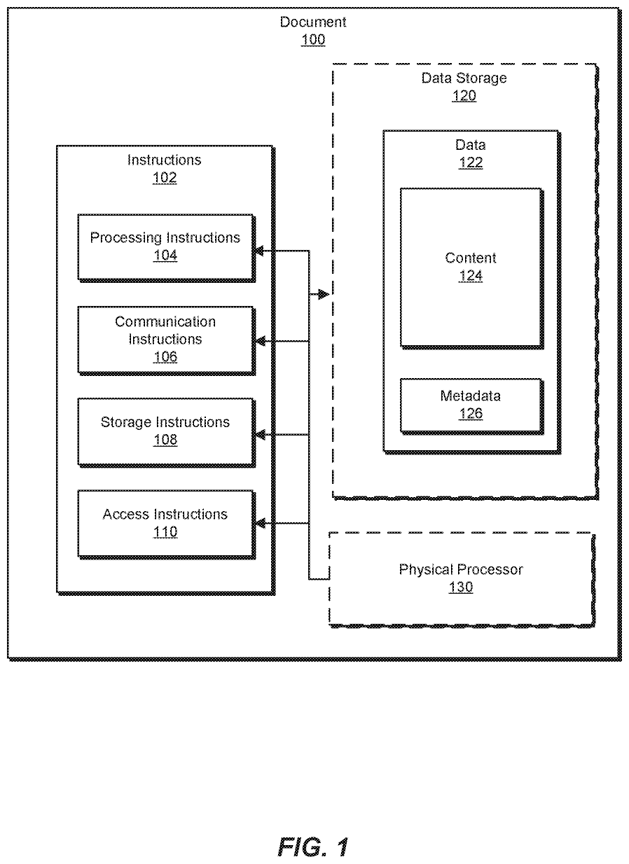

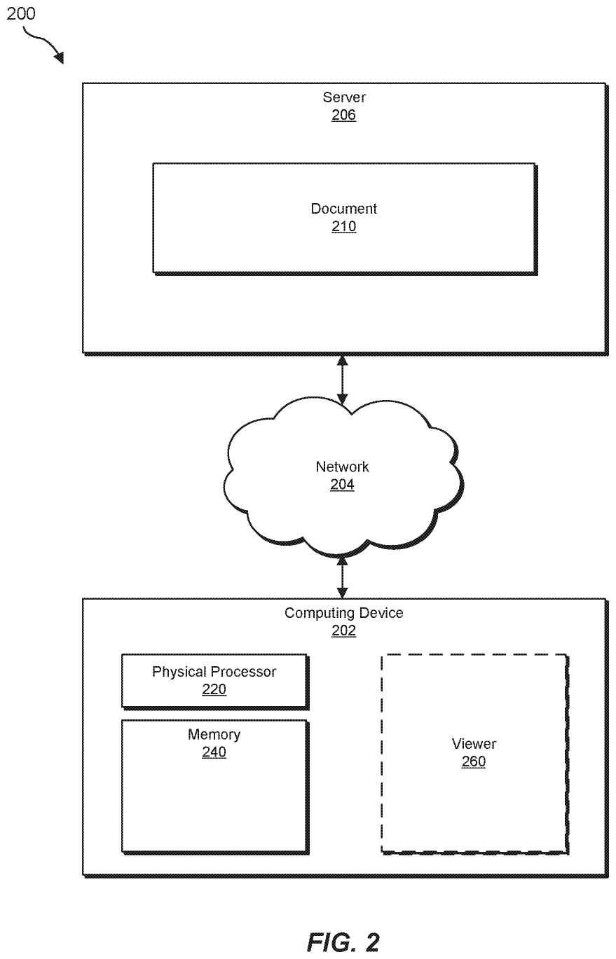

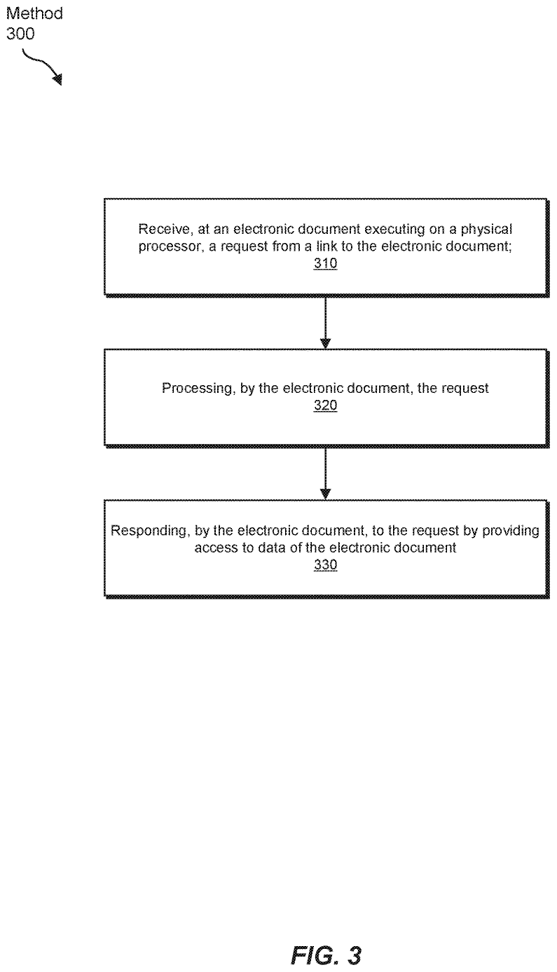

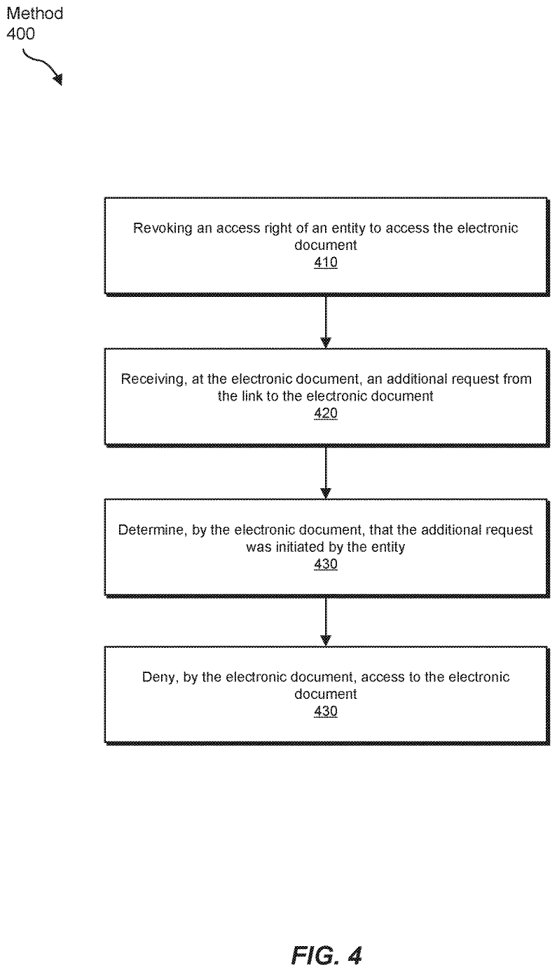

FIGS. 1-4 collectively illustrate the architecture, system, and methods for managing electronic documents provisioned as digital infrastructure. FIG. 1 depicts the internal structure of a Document 100 as a smart digital object, highlighting its embedded instructions, including Storage Instructions 108, Access Control Instructions 110, and Processing instructions 104, which interact with Data Storage 120 and a Physical Processor 130 to enable secure and dynamic document management. FIG. 2 presents a system architecture where the Document 210 is stored on a Server 206 connected to a Network 204, allowing interaction with Computing Devices 202 equipped with a physical Processor 220, Memory 240, and a Viewer 260 for rendering and managing the document. FIG. 3 outlines a Method 300 for processing access requests to the document, including receiving a request (310), processing it (320), and responding by providing access to the document's data (330). FIG. 4 details a method (400) for revoking access rights, handling additional access requests, and denying access to unauthorized entities, ensuring robust control and security over the document's lifecycle. Together, these figures demonstrate a comprehensive framework for transforming traditional documents into active, controllable entities within modern digital ecosystems.

FIG. 1 illustrates the internal structure of a Document 100 provisioned as a smart digital object, designed to enable secure, dynamic, and interactive document management. The Document 100 includes several embedded components, such as Processing Instructions 104, Communication Instructions 106, Storage Instructions 108, Access Instructions 110, Data Storage 120, and a Physical Processor 130. These components work in concert to handle access requests and responses, ensuring robust control and security over the document's lifecycle.

The Processing Instructions 104 play a pivotal role in handling access requests originating from a link or cover page associated with the document. When a user interacts with a link, such as a cover page, icon, or scannable code, the Processing Instructions 104 are activated to evaluate the request. First, the processing instructions verify the authenticity and validity of the request by cross-referencing the credentials of the requesting entity with predefined access rules stored within the document or its associated Data Storage 120. This verification process may involve multi-factor authentication, role-based access control, or other security protocols to ensure that only authorized entities can proceed. Once the request is authenticated, the processing instructions determine the scope of access permitted for the requesting entity. For example, the processing instructions may allow full access to the document, restricted access to specific sections, or deny access entirely based on the user's role, security clearance, or contextual parameters embedded within the document.

The Communication Instructions 106 handle the response to the access request processed by the Processing Instructions 104. Once the request is evaluated and a decision is made, the communication instructions generate and transmit the appropriate response to the requesting entity. If access is granted, the communication instructions facilitate the seamless delivery of the document's content to the user, ensuring that the data is rendered securely and accurately. For instance, the communication instructions may interact with the Storage Instructions 108 to retrieve the relevant Data 122 from the Data Storage 120 and transmit it to the user's device via the network. The communication instructions also ensure that the response is tailored to the user's device and environment, such as reformatting the document for mobile devices or providing encrypted content for secure transmission. Conversely, if access is denied, the communication instructions display a cover page or notification to the user, explaining the denial and providing instructions for requesting access or contacting the document's administrator. Additionally, the communication instructions log the interaction, including details of the request and response, within the document's lifecycle records for auditing and compliance purposes.

In some examples, the data of a self-determinative document can include two distinct components: Content 124 and Metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of Content 124 ensures the integrity and trustworthiness of the document, making it suitable for applications where the original state of the document must be preserved, such as legal agreements, financial reports, or medical records.

On the other hand, Metadata 126 represents supplementary information about the document, such as timestamps, user interactions, access logs, version history, or contextual details. Unlike the immutable content, Metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Together, the Processing Instructions 104 and Communication Instructions 106 enable the Document 100 to act as an intelligent, self-determinative entity capable of securely managing access requests and responses. This architecture ensures that the document remains under the control of its owner or administrator, even when distributed across multiple platforms or accessed by various entities.

FIG. 2 illustrates a system architecture for managing electronic documents, showcasing the interaction between a server 206, a document 210, a network 204, and a computing device 202 equipped with a physical processor 220, memory 240, and a viewer 260.

The server 206 is configured to store the document 210, which represents an electronic document provisioned with embedded intelligence. The server 206 facilitates secure storage and centralized management of the document 210, ensuring that all interactions with the document are routed through a controlled environment. The document 210 may include embedded components that enable dynamic functionality, such as processing instructions 104, communication instructions 106, and access control mechanisms.

The network 204 connects the server 206 to the computing device 202, enabling communication and data exchange between these components. The network 204 may be implemented as a local area network (LAN), wide area network (WAN), or the Internet, providing the infrastructure for transmitting access requests and responses. The network 204 ensures that the document 210 can be accessed remotely by authorized entities, facilitating seamless interaction across distributed systems.

The computing device 202 is equipped with a physical processor 220 and memory 240, which collectively enable the execution of computer-readable instructions associated with the document 210. The physical processor 220 interprets and processes these instructions, while the memory 240 stores the necessary data and modules required for rendering and managing the document. The computing device 202 may take various forms, such as a desktop computer, laptop, tablet, or smartphone, depending on the user's environment and requirements.

The viewer 260 is a component of the computing device 202 that renders the document 210 for user interaction. The viewer 260 may provide functionalities such as displaying the content of the document, enabling navigation through various sections, and facilitating user input. Additionally, the viewer 260 may support context-aware features, such as reformatting the document for different screen sizes or providing tailored access based on the user's role or security clearance. The viewer 260 ensures accessibility and usability of the document 210 across diverse devices and environments.

FIG. 3 illustrates a method 300 for processing access requests to an electronic document provisioned with embedded intelligence, emphasizing the role of a link as the access point to the document. The link, which may take the form of a cover page, icon, scannable code, or bookmark, serves as the gateway to the document's content and functionality. When a user interacts with the link, the document, executing on a physical processor, initiates a sequence of operations to evaluate the request. This process includes receiving the request (310), processing it (320) to determine the user's authorization and scope of access, and responding (330) by providing tailored access to the document's data. The embedded intelligence within the document ensures that access is dynamically managed based on predefined rules, user roles, and contextual parameters, transforming the document into an active, self-determinative entity capable of secure and adaptive interaction.

Step 310, as illustrated in FIG. 3, involves receiving a request at an electronic document provisioned with embedded intelligence, where the request originates from a link serving as the access point to the document. This step \initiates the interaction between the user and the document, triggering subsequent security and access control measures. The link itself can take various forms, such as a cover page, icon, scannable code (e.g., QR code), bookmark, or even a hyperlink embedded in an email or web page. Each of these forms provides a unique entry point to the document, tailored to different use cases and user environments.

For example, a cover page may act as a gateway, displaying basic information about the document, such as its title, author, and a brief summary, while requiring the user to authenticate before accessing the full content. Alternatively, an icon associated with the document may be displayed on a user's desktop or cloud storage interface, allowing the user to click on it to initiate the request. A scannable code, such as a QR code, may be printed on a physical document or displayed on a screen, enabling users to scan it with their mobile devices to access the document. A bookmark may provide direct access to a specific section of the document, allowing users to bypass irrelevant content and focus on the portion they need.

Upon interaction with the link, the document, executing on a physical processor, begins the process of receiving the request. This interaction may involve various scenarios. For instance, a user clicking on a hyperlink embedded in an email may trigger the document to verify the user's identity and determine whether the request is valid. Similarly, scanning a QR code may prompt the document to check the geolocation of the user to ensure that access is being requested from an authorized region.

In another example, a bookmark may include metadata specifying the user's role or clearance level, allowing the document to tailor the access request accordingly. The request itself can include multiple parameters, such as the user's credentials, device information, location, and the specific section of the document being requested. For instance, a request from a corporate employee may include their role within the organization, enabling the document to grant access to sections relevant to their job function while restricting access to sensitive areas. Alternatively, a request from a customer accessing a marketing brochure may include device information, prompting the document to reformat its layout for optimal viewing on a mobile device.

In some embodiments, the document may also receive requests from automated systems or third-party applications. For example, a data analysis tool may request access to extract specific information from the document for reporting purposes. Similarly, a workflow automation system may request access to update the document based on predefined triggers, such as the completion of a task or the approval of a related document.

Step 310 is designed to handle these diverse scenarios while prioritizing security, flexibility, and user experience. The embedded intelligence within the document ensures that the request is received in a structured and secure manner, laying the foundation for subsequent steps in the method, such as processing the request (320) and responding to it (330). By accommodating various forms of links, user interactions, and request parameters, step 310 exemplifies the dynamic and adaptive capabilities of the document as a self-determinative entity.

Step 320, as illustrated in FIG. 3, involves processing the request received at an electronic document provisioned with embedded intelligence. This step is critical for determining the validity, scope, and authorization of the request, ensuring that the document's security and access control measures are upheld. The embedded intelligence within the document, executing on a physical processor, evaluates the request using predefined rules, contextual parameters, and user-specific data to make an informed decision about how to proceed. The first action in step 320 is authenticating the requesting entity, which may involve verifying credentials such as usernames, passwords, biometric data (e.g., fingerprint or facial recognition), or cryptographic keys. Multi-factor authentication (MFA) may be employed, requiring the user to provide a password and verify their identity through a secondary method, such as a one-time code sent to their mobile device. Role-based access control (RBAC) may also be used, cross-referencing the user's role within an organization against access permissions stored within the document's embedded rules. Additionally, geolocation-based verification may be applied, ensuring that access requests originating from scannable codes, such as QR codes, are made from authorized regions.

The document's embedded intelligence evaluates the context of the request to determine its scope and validity. This may include analyzing device-specific parameters, such as tailoring the response for mobile devices by providing simplified layouts, enforcing time-based restrictions that allow access only during business hours or for a limited duration, and considering user-specific preferences, such as preferred language or accessibility settings, to customize the response. Once the request is authenticated and evaluated, the document determines the scope of access permitted for the requesting entity. This may include granting full access to the entire document for administrators or document owners, partial access to specific sections based on the user's role or clearance level, read-only access for viewing without editing or sharing capabilities, or temporary access that automatically revokes permissions after a set duration. For example, a legal contract may display confidential clauses only to attorneys while showing a summary to clients, or a financial report may reveal detailed analytics to executives but only high-level summaries to team members.

If the request is deemed invalid or unauthorized, the document may display a denial message, such as a cover page or notification explaining the denial and providing instructions for requesting access or contacting the administrator. It may also log the denied request, recording details such as the time, user identity, and reason for denial, for auditing and compliance purposes, or trigger alerts to notify the owner or administrator of the unauthorized access attempt. In a corporate environment, for instance, an employee requesting access to a project plan may be granted access only to sections relevant to their department, while sensitive information is hidden. In a legal context, a lawyer requesting access to a contract via an email link may be authenticated and granted access to the full contract but restricted from downloading or printing it. In an educational setting, a student scanning a QR code to access a syllabus may have their enrollment status verified, granting access to the syllabus while restricting supplementary materials reserved for registered students.

In some embodiments, the document may interact with external systems during step 320 to enhance its processing capabilities. For example, it may integrate with third-party authentication services like OAuth or SAML to verify user credentials, workflow automation tools like Salesforce or Jira to update related workflows based on the user's access request, or data analytics platforms to extract or analyze data requested by external applications, such as generating reports or visualizations. The embedded intelligence ensures that step 320 is dynamic and adaptive, updating access permissions as user roles change within an organization or as new content is added to the document. By securely and efficiently processing requests, step 320 exemplifies the document's ability to act as a self-determinative entity, leveraging embedded intelligence to handle diverse scenarios, integrate contextual parameters, and provide tailored access to authorized entities while maintaining control for its owner.

Step 330, as illustrated in FIG. 3, involves responding to the request received at an electronic document provisioned with embedded intelligence by providing tailored access to the document's data. This step ensures that the document dynamically delivers the appropriate content or functionality based on the authorization and scope of access determined in step 320. The embedded intelligence within the document, executing on a physical processor, facilitates this response by interacting with its internal components, such as the storage interface, communication instructions, and access control mechanisms, to securely and efficiently fulfill the request. If the request is authorized, the document may grant full access, partial access, or read-only access, depending on the user's role, security clearance, or contextual parameters. For instance, an executive accessing a financial report may be provided with detailed analytics, while a team member may only see high-level summaries. Similarly, a legal contract may display confidential clauses to attorneys while showing a simplified version to clients. In cases where the request involves accessing specific sections of the document, such as through a bookmark or metadata, the document dynamically renders only the relevant portions, ensuring efficiency and security.

The response may also involve tailoring the document's presentation to the user's device or environment. For example, if the request originates from a mobile device, the document may reformat its layout for optimal readability on smaller screens. Alternatively, if the user is accessing the document in a high-security environment, the response may include additional encryption or watermarking to prevent unauthorized sharing or copying. In cases where the request is denied, the document may display a cover page or notification explaining the denial and providing instructions for requesting access or contacting the administrator. For example, a user attempting to access a restricted section of a document may see a message stating, “Access denied: You do not have the necessary permissions to view this section. Please contact your administrator for further assistance.”

The document's response may also include logging the interaction for auditing and compliance purposes. This log may record details such as the time of the request, the identity of the requesting entity, the scope of access granted or denied, and any actions taken during the interaction. For instance, if a user accesses a document and downloads a specific section, the log may record the download event along with the user's credentials and the timestamp. In some embodiments, the document may trigger alerts to notify the owner or administrator of significant events, such as unauthorized access attempts or changes to access permissions.

In addition to responding to individual requests, the document may facilitate collaborative workflows by synchronizing changes across multiple users and devices. For example, if a team member edits a shared project plan, the document may immediately update the changes for all collaborators, ensuring that everyone is working with the most current version. Similarly, if a user adds comments or annotations to a document, these updates may be visible to other authorized users in real time. The document may also integrate with external systems to enhance its response capabilities. For instance, it may interact with workflow automation tools to trigger related actions, such as updating a task in a project management system or sending notifications to stakeholders.

Step 330 exemplifies the document's ability to act as an intelligent, self-determinative entity, leveraging its embedded intelligence to provide secure, adaptive, and context-aware responses to access requests. By dynamically tailoring its content and functionality to the needs of authorized users while maintaining robust security and control, the document ensures a seamless and efficient user experience while safeguarding its integrity and ownership.

FIG. 4 builds upon the processes outlined in FIG. 3 by introducing a method (400) for managing access rights to an electronic document provisioned with embedded intelligence, particularly focusing on scenarios where access must be revoked or denied. While FIG. 3 emphasizes the initial handling of access requests, including receiving, processing, and responding to such requests, FIG. 4 addresses the lifecycle of access control, detailing how the document dynamically manages changes to access permissions. This includes revoking an entity's access rights (410), receiving additional requests from the same entity (420), determining whether the subsequent request is valid or authorized (430), and denying access if necessary (430). By leveraging its embedded intelligence and executing on a physical processor, the document ensures that access control remains robust, adaptive, and secure, even in complex scenarios where permissions need to be modified or rescinded. FIG. 4 highlights the document's ability to act as a self-determinative entity, maintaining control over its content and interactions while providing a seamless user experience and ensuring compliance with security protocols.

A smart document provisioned with embedded intelligence can dynamically handle annotations, enabling secure, collaborative, and context-aware interactions. Unlike traditional static documents, smart documents adapt annotations based on user roles, permissions, and contextual parameters. For instance, annotations can be role-based, such as managerial comments visible only to team leads, or confidential, such as legal notes accessible only to attorneys. Context-aware annotations may tailor content to specific users, such as regional sales managers viewing market-specific notes. These annotations are not static; they can be updated, synchronized, or removed dynamically. Real-time collaboration allows multiple users to add annotations simultaneously, with changes reflected instantly for all participants, while version control ensures annotations linked to earlier document versions remain accessible after updates.

Temporary annotations can expire automatically, such as comments on draft proposals disappearing after final approval. Security measures govern annotation access, with restricted permissions ensuring only authorized users can view, edit, or delete annotations. Sensitive annotations can be encrypted, and audit trails log all annotation activities for compliance and accountability. Smart documents also integrate annotations with external systems, such as triggering tasks in project management tools or analyzing comments with AI-powered tools to extract insights. Users can customize annotation styles, filter annotations by criteria like author or date, and toggle annotations on or off depending on their needs. Synchronization across devices ensures annotations remain consistent and accessible, even when changes are made offline. Additionally, annotations can be removed or archived based on document lifecycle events, such as deleting outdated comments or preserving negotiation notes for historical reference. By transforming annotations into dynamic, interactive elements, smart documents enhance collaboration, security, and personalization, making them adaptable to diverse scenarios and user needs.

A smart electronic document provisioned with embedded intelligence can handle feedback submissions dynamically, enabling secure, efficient, and context-aware interactions tailored to the needs of users and workflows. Feedback submissions can be integrated directly into the document, allowing users to provide comments, ratings, or suggestions without relying on external tools or systems. For example, a marketing brochure may include an embedded feedback form where users can rate the effectiveness of the content or suggest improvements. Similarly, a legal contract may allow parties to submit negotiation points directly within the document, with each submission linked to specific clauses or sections. Feedback can be role-based, ensuring that only authorized users can provide input on sensitive sections. For instance, board members may submit feedback on strategic sections of a business plan, while employees are restricted to operational areas. Feedback submissions can also be context-aware, adapting to the user's environment or device. For example, a mobile user may be presented with a simplified feedback interface optimized for touch input, while a desktop user may have access to more advanced tools, such as dropdown menus or text fields.

Smart documents can process feedback in real time, enabling collaborative workflows and immediate responses. For instance, a project plan may allow team members to submit feedback on task assignments, with the document dynamically updating to reflect changes or suggestions. Feedback can also be categorized and prioritized based on predefined rules. For example, urgent feedback related to compliance issues in a policy document may be flagged for immediate review, while general comments are stored for later consideration. Feedback submissions can be logged and tracked within the document's lifecycle, ensuring accountability and transparency. Each submission can include metadata such as the user's identity, timestamp, and device information, providing a comprehensive audit trail for compliance purposes. Additionally, feedback can be encrypted to protect sensitive information, ensuring that only authorized parties can access or review submissions. Smart documents can integrate feedback with external systems to enhance functionality. For example, feedback on a product specification document can trigger updates in a project management tool, such as creating tasks in Jira or Trello. Similarly, feedback on a financial report can be analyzed by AI-powered tools to identify trends or generate insights. Feedback submissions can also be tailored to specific workflows. For instance, a document shared under an NDA may restrict feedback to predefined fields, ensuring compliance with legal requirements. Alternatively, a training manual may allow users to submit feedback anonymously, encouraging candid responses.

Users can customize feedback interfaces within smart documents to suit their preferences or needs. For example, feedback forms can include text fields, checkboxes, star ratings, or dropdown menus, depending on the type of input required. Feedback can also be filtered or sorted based on criteria such as urgency, author, or submission date, allowing reviewers to focus on the most relevant input. Smart documents can provide real-time notifications to document owners or administrators when feedback is submitted, enabling prompt responses or actions. For example, a document owner may receive an alert when critical feedback is submitted, allowing them to address issues immediately.

Feedback submissions can be synchronized across devices, ensuring consistency and accessibility. For instance, feedback submitted on a mobile device is immediately visible when accessing the document on a desktop, enabling seamless collaboration across platforms. Offline feedback submissions can be stored locally and synchronized once the device reconnects to the network, ensuring that input is not lost due to connectivity issues. Additionally, feedback can be archived or removed based on document lifecycle events. For example, feedback on a draft proposal may be archived once the final version is approved, preserving input for historical reference while maintaining a clean version of the document.

By leveraging embedded intelligence, smart electronic documents transform feedback submissions into dynamic, interactive elements that enhance collaboration, security, and personalization. This capability ensures that feedback is not only collected efficiently but also processed and integrated in a way that adds value to workflows and decision-making processes.

Smart documents provisioned with embedded intelligence can dynamically export and create reports, transforming raw data and content into actionable insights tailored to user needs and workflows. These documents leverage their embedded intelligence to extract, organize, and format information, ensuring that reports are generated efficiently and securely. For example, a financial report stored as a smart document can automatically compile quarterly performance metrics, compare them with historical data, and export a summary in formats such as PDF, Excel, or HTML. Similarly, a legal document can generate a report highlighting key clauses, compliance risks, and deviations from standard templates, providing attorneys with a concise overview for review. Reports can be customized based on user roles and permissions; for instance, executives may receive high-level summaries, while analysts access detailed data tables and charts. This ensures that the exported reports are tailored to the specific needs of the recipient.

Smart documents can integrate with external systems to enhance reporting capabilities. For example, a smart document can pull data from enterprise resource planning (ERP) systems, customer relationship management (CRM) platforms, or cloud databases to create comprehensive reports. In a corporate setting, a project plan stored as a smart document can generate a report summarizing milestones, resource allocation, and budget utilization, pulling real-time data from project management tools like Jira or Trello. Similarly, a marketing document can export a report comparing campaign performance metrics, integrating data from analytics platforms such as Google Analytics or HubSpot. AI-powered tools embedded within the document can analyze textual, numerical, or graphical data, generating visualizations such as charts, graphs, or dashboards to enhance the report's readability and impact.

for instance, a sales forecast document can export a report with dynamic graphs showing projected revenue growth alongside real-time market trends. Reports generated by smart documents can be formatted in various ways to suit different workflows and preferences. Users can choose from predefined templates or customize the layout, including headers, footers, tables, and visual elements. For example, a researcher may export a report summarizing findings from multiple studies, formatted with citations, footnotes, and a bibliography. A procurement officer may generate a report comparing vendor proposals, including tables of pricing, delivery timelines, and terms. Reports can also be exported in multiple formats, such as PDF for secure sharing, Excel for data manipulation, or HTML for web-based presentation. Additionally, smart documents can export reports directly to external systems, such as uploading a financial summary to an accounting platform or sending a compliance report to a regulatory body.

Smart documents can automate the reporting process, reducing manual effort and ensuring consistency. For example, a smart document tracking inventory levels can automatically generate and export weekly stock reports to relevant stakeholders. Similarly, a policy document can schedule the creation of compliance reports at regular intervals, ensuring that updates are shared with auditors or legal teams. Reports can also be triggered by specific events, such as the completion of a task, the approval of a document, or the detection of anomalies in data. For instance, a smart document monitoring cybersecurity risks can generate and export a report when unusual activity is detected, providing IT teams with detailed logs and recommendations.

Security and access control can be part of the reporting process. Smart documents can ensure that exported reports are encrypted and accessible only to authorized users. For example, a financial report containing sensitive data can be password-protected or shared via secure links. Audit trails can log all reporting activities, including who generated the report, the data included, and the recipients, ensuring accountability and compliance. Additionally, smart documents can watermark exported reports to prevent unauthorized distribution or tampering.

Reports generated by smart documents can be synchronized across devices, ensuring accessibility and consistency. For example, a report created on a desktop can be accessed on a mobile device, allowing users to review insights on the go. Offline reports can be queued and exported once the device reconnects to the network, ensuring that workflows are not disrupted. Reports can also be archived within the smart document for future reference, enabling users to track changes and trends over time.

By leveraging embedded intelligence, smart documents transform reporting into a dynamic, interactive process that enhances decision-making, collaboration, and efficiency. Whether exporting summaries, detailed analyses, or visual dashboards, smart documents provide users with tailored reports that integrate seamlessly into diverse workflows, making them invaluable tools in scenarios such as financial planning, legal compliance, research, and strategic decision-making.

Smart documents provisioned with embedded intelligence can dynamically create and manage bookmarks, enabling users to navigate, organize, and access specific sections of a document efficiently. Unlike traditional static bookmarks, smart bookmarks are interactive and context-aware, adapting to user roles, preferences, and workflows. For example, a legal contract may include bookmarks for key clauses, such as confidentiality agreements or payment terms, allowing attorneys to quickly locate and review critical sections. Similarly, a financial report may feature bookmarks for quarterly summaries, detailed analytics, and projections, enabling executives to focus on relevant data without scrolling through the entire document. These bookmarks can be personalized based on user roles; for instance, a manager may see bookmarks for team performance metrics, while a team member sees bookmarks for individual tasks or deliverables.

Smart bookmarks can be created automatically by leveraging embedded intelligence within the document. For example, the document can analyze its structure and content to identify logical sections, such as headings, tables, or figures, and generate bookmarks accordingly. In a research paper, the document may automatically create bookmarks for the abstract, methodology, results, and references, ensuring that readers can navigate the document seamlessly. Alternatively, users can manually create bookmarks by selecting specific text, images, or sections, and assigning labels or tags to them. For instance, a project manager reviewing a proposal may bookmark sections related to budget estimates and timelines, adding custom tags like “Budget Review” or “Critical Deadlines” for easy reference.

Bookmarks in smart documents can also be dynamic, updating automatically as the document evolves. For example, if a bookmarked section is edited or moved, the bookmark adjusts to reflect the changes, ensuring that users always access the correct content. In collaborative environments, bookmarks can be shared among team members, enabling consistent navigation across devices and users. For instance, a marketing team working on a campaign document may share bookmarks for key sections, such as target audience profiles or creative concepts, ensuring that all members can quickly access relevant information. Smart bookmarks can integrate with external systems to enhance functionality. For example, a bookmark in a project plan may link to a task in a project management tool like Jira or Trello, allowing users to transition seamlessly between the document and related workflows. Similarly, a bookmark in a compliance report may link to regulatory guidelines stored in an external database, providing users with additional context. AI-powered tools embedded within the document can analyze bookmarked sections to generate insights or recommendations. For instance, a bookmark in a sales forecast document may trigger an AI analysis of market trends, providing users with actionable data.

Bookmarks can also be customized to suit individual user preferences. Users can choose how bookmarks are displayed, such as in a sidebar, dropdown menu, or interactive table of contents. They can organize bookmarks into categories or hierarchies, enabling structured navigation. For example, a procurement officer may group bookmarks for vendor proposals under categories like “Pricing,” “Delivery Timelines,” and “Terms and Conditions.” Users can also filter bookmarks based on criteria such as tags, authors, or creation dates, ensuring that they focus on the most relevant sections.

Security and access control are integral to bookmark management in smart documents. Bookmarks can be restricted based on user roles or permissions, ensuring that sensitive sections are only accessible to authorized users. For example, a bookmark for confidential financial data may be visible only to senior executives, while general employees see bookmarks for public-facing summaries. Audit trails can log bookmark activities, such as creation, modification, or deletion, providing accountability and compliance.

Smart bookmarks are synchronized across devices, ensuring consistency and accessibility. For example, a bookmark created on a desktop is immediately available when accessing the document on a mobile device. Offline bookmarks can be stored locally and synchronized once the device reconnects to the network, ensuring that workflows are not disrupted. Additionally, bookmarks can be archived or removed based on document lifecycle events. For instance, bookmarks in a draft proposal may be archived once the final version is approved, preserving navigation history for future reference.

By leveraging embedded intelligence, smart documents transform bookmarks into dynamic, interactive tools that enhance navigation, organization, and collaboration. Whether used for quick access to critical sections, integration with external workflows, or personalized navigation, smart bookmarks provide users with a seamless and efficient way to interact with complex documents, making them invaluable in scenarios such as legal analysis, project management, research, and strategic planning.

Smart documents provisioned with embedded intelligence can dynamically provide agent access via links or entry points, enabling automated systems, applications, or AI agents to interact with the document in a secure, efficient, and context-aware manner. These entry points, such as cover pages, icons, scannable codes, or embedded hyperlinks, act as gateways for agents to access, retrieve, or manipulate the document's content and metadata. For example, a cover page may provide metadata about the document, such as its title, version history, and access permissions, allowing a compliance agent to verify regulatory requirements before accessing the content. Similarly, an icon associated with the document may serve as an entry point for workflow automation tools to retrieve the document and update related tasks in a project management system. Scannable codes, such as QR codes, can enable logistics systems to extract delivery details from a shipping manifest, while hyperlinks embedded in emails or web pages can direct agents to specific sections or functionalities of the document, such as a financial table for analysis. When an agent interacts with a smart document via an entry point, the document ensures secure authentication and authorization through mechanisms like API keys, role-based access control (RBAC), and contextual evaluation of parameters such as location, device type, or time of access. For instance, a marketing analytics agent may access campaign performance data, while a financial auditing agent accesses compliance-related sections.

Smart documents dynamically adapt their behavior based on the agent's needs and the context of the interaction. For example, an AI agent analyzing a legal contract may extract specific clauses, such as indemnity provisions, without accessing the entire document, while a financial forecasting agent retrieves real-time revenue figures to generate predictive models. Workflow automation agents can update task statuses, assign resources, or generate progress reports based on the document's content. Integration with external systems further enhances functionality, allowing enterprise resource planning (ERP) systems to retrieve purchase order details, customer relationship management (CRM) platforms to extract customer data, and cloud services to synchronize document data across distributed systems. For example, a contract management agent may access a smart document via a hyperlink to verify compliance with jurisdictional requirements, while a healthcare agent retrieves diagnostic data from a patient's smart document via a secure link to update treatment plans.

Smart documents also allow customization of entry points to suit specific workflows or user preferences. Users can configure entry points to provide agents with access to specific sections or functionalities, such as enabling procurement agents to access vendor pricing data. Entry points can also be programmed to grant access conditionally, such as after verification processes or submission of credentials. Security is integral to agent access, with smart documents encrypting interactions and maintaining audit trails to log all agent activities, including the time, nature of the request, and data accessed. Access can be revoked if credentials are compromised or interactions violate predefined rules.

Synchronization across devices ensures seamless interaction, allowing agents to retrieve the same data whether accessing the document on a desktop or mobile device. Offline interactions can be queued and processed once the device reconnects to the network, ensuring uninterrupted workflows. By leveraging embedded intelligence, smart documents transform entry points into dynamic, secure gateways for agent access, enabling automated systems to interact with documents efficiently and contextually. Whether extracting data, automating workflows, or integrating with external platforms, smart documents provide agents with tailored access that enhances collaboration, decision-making, and operational efficiency across diverse scenarios.

Smart documents provisioned with embedded intelligence can implement self-translation capabilities, enabling dynamic, accurate, and context-aware translation of their content into multiple languages without requiring external tools or systems. This functionality is particularly valuable in globalized environments where documents need to be accessible to users across different regions and linguistic backgrounds. Self-translation is achieved through embedded AI-powered language models that analyze the document's structure, context, and metadata to generate translations tailored to the intended audience. For example, a legal contract stored as a smart document can automatically translate its clauses into French, Spanish, or Mandarin while preserving the legal terminology and formatting specific to each language. Similarly, a marketing brochure can dynamically translate its content into the target audience's native language, ensuring cultural relevance and maintaining the integrity of the brand message.

Self-translation in smart documents can be context-aware, adapting the translation based on the user's role, location, or preferences. For instance, a financial report accessed by a user in Germany may be translated into German, while the same report accessed by a user in Japan is translated into Japanese. Additionally, the document can tailor the translation to the user's expertise level; for example, a technical manual may provide simplified translations for general users while offering detailed, industry-specific terminology for engineers. Smart documents can also integrate with geolocation services to automatically detect the user's region and provide translations in the appropriate language. For example, a smart document accessed in Brazil may default to Portuguese, while the same document accessed in Argentina defaults to Spanish.

The embedded intelligence within smart documents ensures that translations are not only linguistically accurate but also contextually appropriate. For example, idiomatic expressions in the source language can be replaced with culturally equivalent phrases in the target language, ensuring that the translation resonates with the audience. In a corporate setting, a smart document containing a CEO's message to employees may translate motivational phrases into culturally relevant equivalents for different regions, preserving the tone and intent of the original message. Similarly, a product specification document may adapt technical terms to align with industry standards in the target language, ensuring clarity and compliance. Smart documents can also provide users with options to customize the translation process. For instance, users may select their preferred language from a dropdown menu or specify the level of formality for the translation. A legal team reviewing a translated contract may opt for a formal tone, while a marketing team working on a campaign document may prefer a conversational tone. Additionally, users can toggle between the original language and the translated version, allowing them to cross-reference the content for accuracy. For example, a bilingual user reviewing a translated report may switch between the English and Spanish versions to ensure consistency.

Self-translation capabilities in smart documents can be enhanced through integration with external systems and AI tools. For example, the document may connect to cloud-based translation services to access specialized language models for rare or complex languages. In a healthcare setting, a smart document containing patient records may integrate with medical translation databases to ensure accurate translation of diagnostic terms and treatment protocols. Similarly, a smart document used in international trade may connect to legal translation services to ensure compliance with jurisdiction-specific regulations.

Security and access control are integral to the self-translation process. Smart documents ensure that translations involving sensitive information are encrypted and accessible only to authorized users. For example, a legal document translated into multiple languages for an international merger may restrict access to the translated versions based on user roles. Audit trails can log all translation activities, including the languages selected, the users initiating the translations, and the time of access, ensuring accountability and compliance.

Self-translation in smart documents is synchronized across devices, ensuring consistency and accessibility. For example, a user accessing a translated document on their desktop can retrieve the same translation on their mobile device. Offline translations can be queued and processed once the device reconnects to the network, ensuring uninterrupted workflows. Additionally, translations can be archived within the smart document for future reference, enabling users to track changes and compare translations over time.

By leveraging embedded intelligence, smart documents transform self-translation into a dynamic, interactive process that enhances accessibility, collaboration, and efficiency. Whether translating legal contracts, technical manuals, or marketing materials, smart documents provide users with accurate, context-aware translations tailored to their needs, making them invaluable tools in globalized environments and multilingual workflows.

A link to a smart document can take the form of a QR code or other scannable code, providing a seamless and secure entry point for accessing the document's content and functionality. QR codes can be printed on physical documents, displayed on screens, or embedded within emails or web pages, enabling users to scan them with mobile devices to initiate access. For example, a QR code on a shipping manifest can allow logistics personnel to retrieve delivery details directly from the smart document, while a QR code on a marketing brochure can direct customers to interactive product information. Beyond QR codes, other scannable codes, such as barcodes or NFC (Near Field Communication) tags, can serve as links to smart documents, offering additional flexibility for specific use cases. NFC tags, for instance, can be embedded in physical objects, allowing users to tap their devices to access associated smart documents, such as warranty information or user manuals. These scannable codes can be configured to enforce access controls, ensuring that only authorized users can interact with the document. For example, scanning a QR code may prompt the user to authenticate their identity or verify their location before granting access. Additionally, scannable codes can provide context-aware functionality, such as linking to localized content based on the user's geolocation or device type. By leveraging QR codes and other scannable technologies, smart documents offer intuitive and versatile entry points that enhance accessibility, security, and user experience across diverse scenarios.

The link or entry point to a smart document serves as a critical mechanism for enabling control and visibility over the document's lifecycle and interactions. By acting as a gateway, the link ensures that access to the document is governed by predefined rules and permissions, allowing the document owner or administrator to maintain control even after the document is shared. For example, a link embedded in a cover page or QR code can require authentication before granting access, ensuring that only authorized users can interact with the document. This authentication process may involve multi-factor verification, role-based access control, or contextual checks such as geolocation or device type. Additionally, the link can enforce granular access permissions, such as restricting certain users to specific sections of the document or providing read-only access while preventing downloads or edits. Beyond access control, the link also provides visibility into document interactions by logging all activities associated with the entry point. For instance, the document can record details such as the time of access, the identity of the user, the actions performed (e.g., viewing, editing, or sharing), and the device used. These logs create a comprehensive audit trail that enhances accountability and compliance, allowing the document owner to monitor usage patterns, detect unauthorized access attempts, and respond to security incidents. Furthermore, the link can dynamically adapt to changing conditions, such as revoking access for users who no longer meet the required criteria or updating permissions based on new organizational policies. By integrating control and visibility into the entry point, smart documents ensure that their content remains secure, manageable, and transparent, even in complex workflows involving multiple users and systems.

Encrypting the entry page or cover page of a smart document adds an additional layer of security, ensuring that unauthorized users cannot access sensitive information or interact with the document without proper authentication. Encryption can be applied to the entire cover page or specific elements, such as the metadata, links, or instructions embedded within it. For example, a cover page containing a hyperlink to the document's secure cloud location can be encrypted using advanced cryptographic algorithms, such as AES (Advanced Encryption Standard) or RSA (Rivest-Shamir-Adleman), to prevent interception or tampering during transmission. Alternatively, the encryption can be tied to user-specific credentials, ensuring that only authorized users with the correct decryption keys can view or interact with the cover page. In one scenario, the cover page may require the user to input a password or complete multi-factor authentication before decrypting and displaying the document's access link. Another alternative involves encrypting the cover page based on contextual parameters, such as geolocation or device type, ensuring that access is granted only under specific conditions. For instance, a cover page may only decrypt when accessed from a registered device or within an authorized geographic region.

In addition to encryption, the cover page can incorporate dynamic security features, such as time-sensitive decryption keys that expire after a set duration, ensuring temporary access. For example, a user may receive a one-time decryption key via email or SMS, valid for only 24 hours, to access the cover page. Another alternative involves integrating biometric authentication, such as fingerprint or facial recognition, to decrypt the cover page, ensuring that access is tied to the user's physical identity. Furthermore, the encrypted cover page can include a visible watermark or digital signature to verify its authenticity, preventing unauthorized duplication or forgery. In collaborative environments, the encryption can be role-based, allowing different users to decrypt and view specific sections of the cover page based on their permissions. For instance, a manager may decrypt the cover page to access administrative controls, while a team member sees only basic document information.

Encrypted cover pages can also integrate with external systems to enhance security. For example, the encryption keys can be managed through a centralized key management system (KMS), ensuring secure distribution and revocation of keys as needed. Alternatively, the cover page can leverage blockchain technology to store encryption keys and access logs, providing an immutable record of interactions. In high-security environments, the cover page can be encrypted using hardware-based encryption, such as Trusted Platform Modules (TPMs), ensuring that decryption occurs only on authorized devices. Additionally, the cover page can include a self-destruct mechanism, where the encrypted content is automatically deleted after a certain number of failed decryption attempts, preventing brute-force attacks.

By encrypting the entry page or cover page, smart documents ensure that access remains secure, controlled, and adaptable to diverse scenarios. Whether through password protection, biometric authentication, time-sensitive keys, or integration with external systems, encrypted cover pages provide robust security while maintaining flexibility and usability. This capability is particularly valuable in workflows involving sensitive information, such as legal contracts, financial reports, or proprietary data, where unauthorized access could have significant consequences.

A link, entry page, or cover page in a smart document can serve as a pivotal mechanism for enabling control and visibility over the document's lifecycle and interactions. Acting as a secure gateway, it ensures that access to the document is governed by predefined rules and permissions, allowing the document owner or administrator to maintain control even after the document is shared. For example, a cover page embedded with a link to the document's secure cloud location can require authentication before granting access, ensuring that only authorized users can interact with the document. This authentication process may involve multi-factor verification, role-based access control (RBAC), or contextual checks such as geolocation, device type, or time of access. Additionally, the cover page can enforce granular access permissions, such as restricting certain users to specific sections of the document or providing read-only access while preventing downloads, edits, or sharing. For instance, a legal contract may allow attorneys to view confidential clauses while limiting clients to a summary of the agreement.

Beyond access control, the link or cover page can facilitate visibility into document interactions by communicating all activities associated with the entry point for logging at the smart document. The document can record details such as the time of access, the identity of the user, the actions performed (e.g., viewing, editing, or sharing), and the device used. These logs create a robust audit trail that enhances accountability and compliance, allowing the document owner to monitor usage patterns, detect unauthorized access attempts, and respond to security incidents. For example, if a user attempts to access restricted sections of a document, the cover page can log the attempt and notify the administrator, enabling proactive intervention.

The cover page can also dynamically adapt to changing conditions, such as revoking access for users who no longer meet the required criteria or updating permissions based on new organizational policies. For instance, if an employee leaves a company, the cover page can show that they no longer have access to sensitive documents, ensuring that proprietary information remains secure. Additionally, the cover page can display tailored notifications or instructions based on the user's role or access level. For example, a manager accessing a project plan may see administrative controls, while a team member sees only task-specific details.

In collaborative environments, the cover page can facilitate controlled sharing by allowing the document owner to specify access parameters for different stakeholders. For instance, a marketing team may share a campaign document with external partners via a cover page that restricts access to certain sections while enabling real-time collaboration on others. The cover page can also integrate with external systems, such as project management tools or compliance platforms, to enhance visibility and control. For example, it can synchronize access logs with a centralized database or trigger alerts in workflow automation systems when specific actions are performed.

By embedding control and visibility into the link, entry page, or cover page, smart documents ensure that their content remains secure, manageable, and transparent, even in complex workflows involving multiple users and systems. This capability is particularly valuable in scenarios such as legal compliance, financial reporting, and collaborative projects, where maintaining control and tracking interactions are critical to ensuring security and accountability.

Smart documents accessible via entry pages significantly enhance searchability by leveraging embedded intelligence and centralized access points, making them ideal for AI training and advanced data retrieval. Unlike traditional documents, which are often scattered across multiple locations and formats, smart documents consolidate their content into a single, secure instance accessible through entry pages such as cover pages, links, or scannable codes. These entry pages act as gateways to the document's metadata, structure, and content, enabling efficient indexing and retrieval. For example, a smart document may include metadata tags embedded within its entry page that describe its subject matter, version history, and associated workflows, allowing AI systems to quickly identify and categorize the document for training purposes.

The centralized nature of smart documents ensures that AI models can access the most accurate and up-to-date information without encountering duplicate or outdated versions. For instance, when training an AI model on legal contracts, the entry page can provide direct access to the latest version of the document while maintaining links to previous versions for historical context. This eliminates the inefficiencies associated with searching through fragmented copies stored across different systems. Additionally, the entry page can display contextual information, such as the document's relationship to other documents or its relevance to specific workflows, further enhancing the AI's ability to understand and process the data. Smart documents also improve searchability by enabling dynamic filtering and querying through their entry pages. For example, an AI system can query a collection of smart documents to retrieve only those related to a specific topic, such as compliance policies or financial reports, by analyzing the metadata and tags provided by the entry pages. This capability is particularly useful in large-scale AI training scenarios where vast amounts of data need to be processed efficiently.

The enhanced searchability of smart documents also supports AI training by providing rich, annotated datasets. For instance, a smart document used in a marketing campaign may include annotations, comments, and feedback accessible via the entry page, offering valuable insights into user interactions and preferences. These annotations can be used to train AI models on sentiment analysis, customer behavior, or content optimization. Similarly, a smart document containing scientific research may include bookmarks and links to related studies, enabling AI systems to establish connections and draw insights across multiple sources.

Security and access control mechanisms embedded in the entry pages further ensure that AI training is conducted responsibly and ethically. For example, the entry page can restrict access to sensitive sections of the document, allowing AI systems to train only on authorized data. Audit trails maintained by the entry page can log all interactions, providing transparency and accountability in the AI training process. Additionally, the entry page can enforce compliance with data privacy regulations, such as GDPR or HIPAA, by ensuring that only anonymized or aggregated data is used for training.

By improving searchability and providing structured, centralized access to content, smart documents accessible via entry pages enable AI systems to train on high-quality, relevant datasets. This capability not only enhances the efficiency and accuracy of AI models but also ensures that training is conducted securely and ethically. Whether used for legal analysis, financial forecasting, or customer insights, smart documents transform the way data is accessed and utilized, making them invaluable tools for modern AI-driven workflows.

Entry pages in smart documents provide dynamic features that enhance accessibility, security, and interactivity, transforming traditional static documents into active, context-aware entities. These entry pages act as gateways to the document's content and functionality, adapting their behavior based on user roles, device types, geolocation, and other contextual parameters. For example, an entry page for a legal contract may display different sections depending on the user's role—attorneys may see confidential clauses, while clients are presented with a simplified summary. Similarly, a marketing brochure accessed via an entry page may reformat its layout for optimal readability on mobile devices, ensuring a seamless user experience across platforms. Entry pages can also provide localized content based on geolocation; for instance, a product catalog accessed in France may default to French language and regional pricing, while the same catalog accessed in Japan displays content tailored to Japanese users.

Dynamic features of entry pages extend to security and access control. For example, an entry page may enforce multi-factor authentication, requiring users to verify their identity through a combination of passwords, biometric data, or one-time codes before granting access. Additionally, entry pages can restrict access based on time-sensitive conditions, such as allowing temporary access for 24 hours or during business hours only. In collaborative environments, entry pages can dynamically adjust permissions, enabling different stakeholders to access specific sections of the document while maintaining overall security. For instance, a project plan may allow team members to view task assignments while granting managers access to budget details.

Entry pages also facilitate real-time updates and notifications. For example, an entry page for a shared document may display alerts about recent changes, such as edits made by collaborators or new comments added. In workflows requiring approvals, the entry page can dynamically update to show the current status of the document, such as pending signatures or completed reviews. Furthermore, entry pages can integrate with external systems to trigger automated actions. For instance, an entry page linked to a compliance report may connect to a regulatory database to verify adherence to updated laws, or a financial report's entry page may pull real-time market data to refresh analytics.

Customization is another dynamic feature provided by entry pages. Users can personalize the appearance and functionality of entry pages to suit their preferences or workflows. For example, a user may configure an entry page to display frequently accessed sections of a document or add shortcuts to related resources. Entry pages can also include interactive elements, such as embedded forms, charts, or calculators, allowing users to perform tasks directly within the entry page without opening the full document. For instance, a sales forecast document's entry page may include a calculator for adjusting revenue projections based on updated parameters.

Dynamic features also extend to tracking and analytics. Entry pages can log user interactions, such as access times, actions performed, and devices used, providing valuable insights into document usage patterns. These logs can be used for auditing, compliance, or optimizing workflows. For example, a company may analyze entry page data to identify frequently accessed sections of a training manual and prioritize updates to those areas.

By leveraging embedded intelligence, entry pages provide dynamic features that adapt to diverse scenarios and user needs, enhancing the functionality, security, and usability of smart documents. Whether enabling tailored access, facilitating real-time updates, or integrating with external systems, entry pages transform documents into interactive, context-aware tools that streamline workflows and improve user experiences.

In the context of smart documents with dynamic entry pages, the information embedded within the entry page or cover page can include the unique address of the secure cloud-stored version of the document, ensuring centralized access and control. In an alternative embodiment, the entry page may also store an encrypted copy of the original document as an “insurance policy” or “recovery plan” to address scenarios where the secure cloud storage facility is compromised due to unforeseen events, such as a Force Majeure or system failure. In such cases, the document controller, owner, or a senior company official, such as the CEO, General Counsel, or head of IT, can initiate a “break-the-glass” protocol. This protocol may involve pushing a button or executing a predefined action that automatically decodes the encrypted documents and replaces the locally stored entry pages with unencrypted original versions. This emergency mechanism allows the organization to revert to a pre-smart document state, where distributed copies of the documents are stored locally on individual devices or other memory locations, enabling the company to continue its primary functions without disruption.

Once the emergency situation is resolved, the organization can re-enable the smart document system by re-converting its documents to smart documents, either through the process described in FIG. 4 or a broader sweep to restore centralized control. Variations of this recovery process can be implemented to decode only a subset of critical documents rather than all documents, ensuring that the recovery effort is tailored to the specific needs of the organization. For example, only high-priority legal contracts or financial reports may be decoded, while less critical documents remain encrypted and centralized. This approach ensures that the dynamic features of entry pages, such as real-time updates, tailored access, and integration with external systems, can be reinstated once the system is stabilized, allowing the organization to resume leveraging the full functionality and security of smart documents.

In the context of smart documents with dynamic entry pages, an alternative embodiment may involve slightly modifying the original document before re-storing it in its original location. Specifically, the link to the secure cloud location containing the copy of the document can be embedded within a container associated with the original document, rather than replacing the original document entirely with a cover page. This approach allows the original document to retain its traditional format while still benefiting from enhanced searchability and centralized access provided by the embedded link.

The decision to implement this partial modification rather than a full replacement depends on the entity's objectives. While many entities prioritize security and control, others may focus on improving the searchability of their document database or enhancing AI training capabilities. For example, embedding links within the original documents ensures that all important documents are included in a centralized Master Data Record, eliminating duplicates and providing confidence that no critical documents are missing. This streamlined record can then be used as high-quality training data for AI engines, ensuring accurate and efficient processing without the risk of overcounting due to duplicate copies.

For entities that prioritize ease of use and simplicity over security, maintaining traditional documents, such as standard PDFs, stored locally by users may be preferable. In this scenario, users can continue to open, share, and interact with documents in the same ways they did previously, without introducing additional layers of control or encryption. While this approach does not provide the robust security features of a fully centralized system, it still enables the organization to leverage the benefits of enhanced searchability and AI training by embedding links within the documents. This hybrid approach balances the simplicity of traditional workflows with the advantages of centralized data management, allowing entities to achieve their goals without disrupting established practices.

In an alternative embodiment, the original document may be slightly modified before being re-stored in its original location. Specifically, the link to the secure cloud location containing the copy of the document can be embedded within a container associated with the original document, rather than replacing the original document entirely with a cover page. This approach allows the original document to retain its traditional format while still benefiting from enhanced functionality, such as centralized access and dynamic features associated with the secure cloud location. For example, when a user opens the document using a specialized reader, the reader can exercise the embedded link to check for updates, such as newly added files or changes to the document. If the document is a form, such as a contract, the link can ensure that signatures or other overlays are properly rendered, providing a seamless and dynamic user experience.

The decision to implement partial modification rather than a full replacement depends on the entity's priorities. While some entities may prioritize security and control, others may focus on improving searchability or enhancing AI training capabilities. Embedding links within the original documents ensures that all important documents are included in a centralized database, eliminating duplicates and providing confidence that no critical documents are missing. This streamlined record can then be used as high-quality training data for AI engines, ensuring accurate and efficient processing without the risk of overcounting due to duplicate copies. Additionally, partial modification allows users to continue interacting with traditional documents, such as PDFs, in familiar ways, while still leveraging the benefits of centralized data management and advanced search capabilities.

Another advantage of embedding links is the ability to capture metadata related to document proliferation. For example, the system can track how many copies of a document exist within the organization or which departments have the highest concentration of a particular document. This information can be valuable for both search and AI contexts. For instance, search criteria can prioritize documents that are widely distributed across the organization or focus on documents heavily concentrated in specific departments, such as Finance or HR. These insights can also inform AI training, allowing the engine to incorporate contextual data about document usage and relevance within the organization.

Using a centralized database of documents as input to an AI engine also helps address the risk of AI leaks. Feeding large sets of data to an AI engine can inadvertently result in the disclosure of confidential information if the engine algorithmically incorporates widely repeated language into its outputs. By exercising control over the input documents, such as selecting which documents to include or exclude, organizations can minimize the risk of leaks and ensure that any inadvertent disclosure can be traced back to its source. This level of control not only enhances security but also provides a framework for corrective measures if an AI leak occurs. By combining traditional document formats with embedded links and centralized management, organizations can achieve a balance between usability, advanced functionality, and robust security.

Smart electronic documents utilize cover QR codes or other machine-readable codes as a seamless access point to the document's single source of truth. These codes act as gateways, enabling users to interact with the document in a secure and centralized manner. When scanned, the QR code directs the user to the authoritative version of the document stored in a secure cloud location, ensuring that the information accessed is accurate, up-to-date, and unaltered. This mechanism eliminates the risks associated with fragmented copies or outdated versions, as the QR code always points to the original, verified document. By embedding these codes on the entry page, smart documents provide an intuitive and efficient way for users to access the document's content while maintaining the integrity of the information.

The integration of QR codes or machine-readable codes into smart electronic documents is not merely functional but can also be an aspect of branding and user experience. These codes symbolize the document's connection to a centralized, intelligent system, reinforcing the trust and reliability associated with the brand. Placing QR codes on disconnected, static documents—often referred to as “digital bricks”—undermines their purpose, as these documents lack the dynamic capabilities and centralized control inherent to smart documents. A QR code on a disconnected brick would fail to provide access to the single source of truth, rendering it ineffective and potentially misleading. By ensuring that QR codes are exclusively associated with smart documents, organizations can maintain their brand's integrity and emphasize the advanced functionality of their document ecosystem. Hard to Detect Forgeries

One of the challenges in traditional document systems is the difficulty in detecting forgeries, as static documents can be easily altered without leaving a trace. Smart electronic documents address this issue by embedding QR codes or machine-readable codes that serve as a verification mechanism. These codes are linked to the document's single source of truth, allowing users to instantly confirm the authenticity of the document by scanning the code. If the document has been tampered with or is a counterfeit, the QR code will fail to direct the user to the verified version, immediately signaling a discrepancy. This approach not only simplifies the process of detecting forgeries but also provides a robust layer of security, ensuring that users can trust the documents they interact with.

Smart electronic documents incorporate visual indicators to convey their authenticity to users. These indicators, such as a green checkmark or a secure badge displayed on the entry page, are dynamically generated based on the document's verification status. When a user accesses the document, the system checks its integrity, ownership, and compliance with predefined security protocols. If all criteria are met, the visual indicator confirms that the document is authentic and unaltered. This feature is particularly valuable in scenarios where users need to quickly assess the reliability of a document, such as legal contracts or financial statements. By providing a clear and immediate visual cue, smart documents enhance user confidence and streamline workflows.

The architecture of smart electronic documents is designed to mitigate risks such as data loss and data breaches while maintaining a single source of truth. These documents are stored in multiple secure cloud locations, ensuring redundancy and resilience against system failures or cyberattacks. Despite the distributed nature of the storage, the document's single source of truth remains intact, as all backups are synchronized and governed by the same security protocols. This approach provides a robust safeguard against data loss, as users can access the document from any of the secure locations without compromising its integrity. Additionally, advanced encryption and access control mechanisms protect the document from unauthorized access, ensuring that sensitive information remains secure even in the event of a breach.

Live document assist is a feature of smart electronic documents that provides real-time support and guidance to users interacting with the document. This functionality is embedded within the entry page and can include interactive tutorials, contextual tips, or automated responses to user queries. For example, if a user is filling out a form within the document, live document assist can highlight required fields, suggest relevant information, or provide explanations for complex sections. This feature enhances the user experience by making the document more intuitive and accessible, reducing errors and improving efficiency. By offering dynamic, context-aware assistance, live document assist transforms the document from a static entity into an active participant in the user's workflow.

The entry page of a smart electronic document can enable backwards compatibility with legacy systems and workflows. Designed to mimic the appearance and functionality of traditional static documents, the entry page acts as a bridge between the old and new paradigms. Users accessing the document through legacy viewers or systems can interact with the entry page as they would with a traditional document, while still being directed to the smart document's advanced features and capabilities. This approach allows organizations to adopt smart documents without disrupting existing workflows or requiring immediate upgrades to their infrastructure. By providing backwards compatibility, the entry page facilitates a smooth transition to the intelligent document ecosystem, ensuring that users can leverage the benefits of smart documents while maintaining continuity with their established processes.

A smart electronic document, executing on a physical processor, can receive an access request originating from an entry page. This entry page is designed to render the document in a fixed-layout format, such as PDF or Word, which are legacy file types. For example, a user may click on a link embedded in an email or scan a QR code printed on a physical document. The entry page acts as a gateway, allowing the smart document to interpret the request and initiate a response. The code of the smart document processes the request by identifying the entry page's format and determining the appropriate response based on the document's capabilities.

The smart document can extract metadata, such as the document's creation date, author, version history, or associated workflows, through the entry page. For instance, when a user accesses a contract, the document may provide metadata indicating the parties involved, the date of execution, and the current status of the agreement. The code embedded in the document queries its internal metadata repository and delivers the requested information to the entry page.

The entry page may include a cover page that displays basic information about the document, such as its title, summary, and access permissions. For example, a marketing brochure may show a preview of its contents and a link to the full document. The smart document's code dynamically generates this cover page based on the document's metadata and user access rights.

The entry page may be encrypted to ensure secure access to the document. For example, a legal contract may require the user to input a password or complete multi-factor authentication before decrypting the entry page. The smart document's code integrates encryption algorithms, such as AES or RSA, to protect the entry page and its associated data.

The smart document adapts its layout for optimal viewing on various devices, such as desktops, tablets, and smartphones. For instance, a financial report may reformat its tables and charts for readability on smaller screens. The document's code detects the device type and dynamically adjusts the rendering parameters.

Before responding to the access request, the smart document can verify its digital signature to ensure authenticity and integrity. For example, the document may use RSA or ECDSA algorithms to confirm that the signature matches the public key of the document's owner. The code performs cryptographic operations to validate the signature.

The smart document can provide an interactive interface that allows users to navigate, annotate, or interact with the document. For example, a project plan may include interactive timelines and task assignment features. The document's code generates the interface based on user roles and permissions.

A smart document can authenticate a user by requiring multiple verification steps, such as a password, biometric data, or a one-time code sent to the user's device. For example, accessing a sensitive financial report may require both a password and fingerprint recognition. The document's code integrates authentication protocols to verify the user's identity.

A smart document can check the user's credentials against predefined access control rules stored within the document. For instance, a contract may allow attorneys to view confidential clauses while restricting clients to a summary. The document's code evaluates the credentials and enforces the appropriate access permissions.

A smart document can record all access requests and responses in an audit trail for accountability and compliance. For example, the document may log the time, user identity, and actions performed during the session. The code appends these records to the document's lifecycle history.

A smart document may render specific sections based on the user's request. For example, a user accessing a research paper may request only the methodology section. The document's code identifies the requested section and delivers it to the user.

A smart document can adjust its response to overcome the constraints of legacy formats. For instance, a PDF may not support interactive features, so the document provides a simplified version with hyperlinks to additional resources. The code evaluates the limitations and adapts the response accordingly.

A smart document can transform its fixed-layout format into a dynamic format that supports user interaction. For example, a static marketing brochure may be converted into an interactive presentation with embedded videos. The code reconfigures the document's structure to enable dynamic rendering.

A smart document may connect to external services, such as OAuth or SAML, to authenticate the user. For example, accessing a corporate policy document may require validation through the company's single sign-on system. The code interfaces with the external service to complete the authentication process.

A smart document can verify that the access request originates from a trusted domain. For example, a confidential report may restrict access to users within the company's network. The code checks the domain against a whitelist of authorized sources.

If an access request fails security checks, a smart document can notify an administrator. For example, an attempt to access a restricted document from an untrusted device may trigger an alert. The code generates and sends the notification. A smart document can provide supplementary metadata, such as related documents or workflow status. For example, accessing a project plan may display links to associated task lists and budgets. The code can retrieve and present the contextual metadata.

A smart document can enable users to choose from different versions, such as drafts or final copies. For example, a legal contract may offer access to both the original and amended versions. The code retrieves the available versions and presents them to the user.

A smart document can check its integrity by comparing its current state to the original state recorded during signature application. For example, a signed agreement may verify that no changes have been made since execution. The code performs hash comparisons to ensure integrity.

A smart document may restrict access based on time constraints. For example, a promotional offer may only be accessible during business hours. The code evaluates the request's timestamp and displays a warning if it falls outside permitted parameters.

A smart document may limit access based on the user's location. For example, a compliance report may only be accessible within specific jurisdictions. The code uses geolocation data to enforce location-based restrictions.

A smart document may adapt its interface to match user preferences, such as language or accessibility settings. For example, a training manual may display larger fonts for visually impaired users. The code retrieves user preferences and customizes the interface accordingly.

A smart document may support simultaneous access by multiple users, each viewing different sections. For example, a project plan may allow team members to view task assignments while managers access budget details. The code manages concurrent sessions and enforces access controls.

A smart document may activate applications embedded within the document, such as calculators or annotation tools. For example, a financial report may include a tool for calculating projections. The code launches the application and integrates it into the user interface.

A smart document may display redacted sections with visual indicators, such as black bars or warnings. For example, a legal contract may hide confidential clauses from unauthorized users. The code identifies redacted sections and renders them accordingly.

A smart document is designed to ensure the integrity, authenticity, and traceability of its content and associated audit trail through the use of immutability, a global marker, and embedded intelligence. This structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, an active document, a self-tracking document, a self-assimilating document, a document with executable code, a document with embedded code, and/or in a variety of other ways depending on the context and on the features of the smart document. In any example, a smart electronic document may include three elements, at minimum—data (e.g., content, audit trail, other metadata, etc.), executable code (e.g., an API), and a globally unique marker.

A smart document can be a technical solution to the persistent problem of ensuring data integrity, security, and operational efficiency in digital document systems, which are often vulnerable to unauthorized modifications, fragmented audit trails, and inefficient workflows. This advanced document structure can incorporate immutable content and an immutable audit trail, both immutably connected to an immutable global identifier, creating a tamper-proof and trustworthy framework that ensures the document's content, history, and identity remain intact and verifiable. The machine-readable design of the smart document enables integration with computational systems, enabling automated querying, validation, and processing of its data and interactions. Additionally, a smart document includes embedded intelligence in the form of executable code, which enables it to autonomously enforce access permissions, execute workflows, and dynamically respond to user or system queries. This embedded intelligence transforms the document into a responsive and interactive entity capable of managing its lifecycle independently, providing a robust solution to the challenges of document security, traceability, and operational inefficiencies in modern digital ecosystems.

A smart document can solve the problems of data security, inefficient use of device hardware, and inefficient use of network systems associated with traditional PDFs by leveraging its entry pages, immutable structure, and embedded intelligence. In terms of data security, entry pages act as secure gateways to the smart document, enforcing cryptographic commitments and granular access permissions before granting access to the document's content. This ensures that unauthorized users cannot interact with the document, reducing vulnerabilities inherent in PDFs, which often lack robust access control mechanisms. Regarding device hardware, traditional PDFs can require significant computational resources for rendering, extracting data, and managing versions, often leading to inefficiencies and hardware strain. Entry pages to smart documents streamline these processes by providing lightweight, context-aware previews of the document's content, reducing the need for complex rendering operations and at least partially optimizing the use of device hardware. Similarly, network systems that handle PDFs often experience bandwidth inefficiencies due to the need to transmit large, static files and duplicate versions. Entry pages to smart documents can address this by enabling API-driven interactions that provide access to specific sections or metadata without transmitting the entire document. This approach reduces network bandwidth usage, enhances workflow efficiency, and ensures that documents are securely and efficiently managed across devices and systems, making entry pages a critical component of the smart document's infrastructure.

The described methods may also address the technical problem of securely managing access to electronic documents across distributed systems while maintaining control and visibility over interactions. Traditional document management systems often fail to provide robust mechanisms for controlling access once a document is shared, leading to security vulnerabilities, unauthorized dissemination, and inefficiencies in tracking document usage. The solution leverages hardware and networking improvements to transform documents into active, self-determinative entities capable of executing operations directly within their framework. By embedding executable instructions within the document itself, the method enables the document to interact with hardware components, such as physical processors and memory devices, to securely store data, process access requests, and enforce permissions dynamically. For example, when a request to access the document is received, the physical processor executes embedded instructions to authenticate the requesting entity, evaluate contextual parameters (e.g., device type, geolocation, or time of access), and determine whether access should be granted. This eliminates the need for external systems to mediate access control, reducing latency and enhancing security by localizing decision-making within the document.

Networking improvements further enhance the solution by enabling seamless communication between the document and remote devices. The document can interact with a network infrastructure to transmit encrypted data, synchronize updates, and log interactions for auditing purposes. For instance, when accessed from a remote viewer, the document ensures that its content is rendered securely and consistently across different hardware platforms, leveraging encryption protocols and authentication mechanisms to prevent unauthorized access. Additionally, the document's ability to dynamically adapt its behavior based on network conditions—such as bandwidth availability or device compatibility—ensures efficient and reliable performance in diverse environments.

By integrating hardware and networking capabilities directly into the document's architecture, the method provides a technical solution that improves the functionality of computing devices and networks. It enables secure, real-time document management, reduces reliance on external systems, and enhances the efficiency of workflows involving distributed users and devices. This approach addresses longstanding challenges in document security and accessibility, offering a scalable and robust framework for modern digital ecosystems.

The foregoing detailed description has outlined various embodiments and features of the present disclosure, demonstrating how smart documents provisioned with embedded intelligence address critical technical challenges in document management, security, accessibility, and collaboration. By leveraging hardware and networking improvements, embedded intelligence, and dynamic entry points, these documents transform from static entities into active, self-determinative objects capable of securely managing their lifecycle, interactions, and updates. The described systems and methods provide robust solutions to longstanding issues such as unauthorized access, inefficient workflows, and data fragmentation, while enabling advanced functionalities like real-time updates, tailored access, AI integration, and enhanced searchability. These innovations not only improve the functionality of computing devices and networks but also create new opportunities for seamless collaboration, secure data handling, and efficient decision-making across diverse industries. While specific embodiments have been described, it will be evident to those skilled in the art that various modifications and adaptations can be made without departing from the broader spirit and scope of the present disclosure. Accordingly, the described embodiments should be considered illustrative rather than restrictive, with the scope of the present disclosure defined by the appended claims and their equivalents.
Clause 1. A method comprising: receiving, at an electronic document executing on a physical processor, a request from a link to the electronic document; processing, by the electronic document, the request; responding, by the electronic document, to the request by providing access to data of the electronic document.
Clause 2. The method of clause 1, wherein the link comprises an icon that is associated with the document.
Clause 3. The method of clauses 1-2, wherein the link comprises a cover page for the electronic document that provides information about the electronic document.
Clause 4. The method of clauses 1-3, wherein the cover page is encrypted.
Clause 5. The method of clauses 1-4, wherein the link comprises a bookmark to a specific section of the document.
Clause 6. The method of clauses 1-5, wherein the link comprises a scannable code.
Clause 7. The method of clauses 1-6, wherein the link is configured to, when selected: open a document viewer; and open, within the document viewer, the electronic document.
Clause 8. The method of clauses 1-7, wherein: processing the request comprises determining that the request is from an entity authorized to access the electronic document; and responding to the request comprising providing the entity with access to the electronic document.
Clause 9. The method of clauses 1-8, further comprising: revoking an access right of the entity to the electronic document; receiving, at the electronic document, an additional request from the link to the electronic document; determining, by the electronic document, that the additional request was initiated by the entity; and denying, by the electronic document, access to the electronic document.
Clause 10. A system comprising: at least one physical processor; physical memory comprising computer-executable instructions that, when executed by the physical processor, cause the physical processor to: receive, at an electronic document executing on a physical processor, a request from a link to the electronic document; process, by the electronic document, the request; respond, by the electronic document, to the request by providing access to data of the electronic document.
Clause 11. The system of clause 10, wherein the link comprises an icon that is associated with the document.
Clause 12. The system of clause 10, wherein the link comprises a cover page for the electronic document that provides information about the electronic document.
Clause 13. The system of clauses 10-12, wherein the cover page is encrypted.
Clause 14. The system of clauses 10-13, wherein the link comprises a bookmark to a specific section of the document.
Clause 15. The system of clauses 10-14, wherein the link comprises a scannable code.
Clause 16. The system of clauses 10-15, wherein the link is configured to, when selected: open a document viewer; and open, within the document viewer, the electronic document.
Clause 17. The system of clauses 10-16, wherein: the computer-executable instructions cause the physical processor to process the request by determining that the request is from an entity authorized to access the electronic document; and the computer-executable instructions cause the physical processor to respond to the request comprising providing the entity with access to the electronic document.
Clause 18. The system of clauses 10-17, wherein the computer-executable instructions, when executed by the physical processor, further cause the physical processor to: revoke an access right of the entity to the electronic document; receive, at the electronic document, an additional request from the link to the electronic document; determine, by the electronic document, that the additional request was initiated by the entity; and deny, by the electronic document, access to the electronic document.
Clause 19. A non-transitory computer-readable medium comprising computer-executable instructions that, when executed by at least one of one or more processors of a computing device, cause the computing device to: receive, at an electronic document executing on a physical processor, a request from a link to the electronic document; process, by the electronic document, the request; respond, by the electronic document, to the request by providing access to data of the electronic document.
Clause 20. The non-transitory computer-readable medium of clause 19, wherein the link comprises an icon that is associated with the document.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving, at an electronic document executing on a physical processor, a request from a link to the electronic document;
processing, by the electronic document, the request;
responding, by the electronic document, to the request by providing access to data of the electronic document.

2. The method of claim 1, wherein the link comprises an icon that is associated with the document.

3. The method of claim 1, wherein the link comprises a cover page for the electronic document that provides information about the electronic document.

4. The method of claim 3, wherein the cover page is encrypted.

5. The method of claim 1, wherein the link comprises a bookmark to a specific section of the document.

6. The method of claim 1, wherein the link comprises a scannable code.

7. The method of claim 1, wherein the link is configured to, when selected:
open a document viewer; and
open, within the document viewer, the electronic document.

8. The method of claim 1, wherein:
processing the request comprises determining that the request is from an entity authorized to access the electronic document; and
responding to the request comprising providing the entity with access to the electronic document.

9. The method of claim 8, further comprising:
revoking an access right of the entity to the electronic document;
receiving, at the electronic document, an additional request from the link to the electronic document;
determining, by the electronic document, that the additional request was initiated by the entity; and
denying, by the electronic document, access to the electronic document.

10. The method of claim 1, wherein the electronic document is configured to interact with an artificial intelligence agent using a specialized protocol.

11. The method of claim 10, wherein the specialized protocol comprises a machine communication protocol.

12. The method of claim 1, wherein the electronic document comprises an artificial intelligence application programming interface configured to support artificial intelligence agents in at least one of querying, analyzing, or interacting with the electronic document in a structured manner.

13. The method of claim 1, wherein the electronic document is configured to process a request from an artificial intelligence agent using embedded intelligence of the electronic document in a manner that provides a response tailored to a context of the request.

14. The method of claim 1, wherein the electronic document enforces role-based access control on artificial intelligence agents.

15. The method of claim 1, wherein the electronic document is configured to manage artificial intelligence agent access to the electronic document by autonomously evaluating permissions for one or more specific portions of the electronic document.

16. The method of claim 1, wherein the electronic document is configured to restrict access of an artificial agent to a sensitive portion of the electronic document.

17. The method of claim 1, wherein the electronic document is configured to allow an artificial agent to train only on data that the electronic document authorizes for training.

18. The method of claim 1, wherein the electronic document is configured to ensure that an artificial intelligence agent uses the electronic document for training in a manner that is both secure and ethical.

19. The method of claim 1, wherein the electronic document is configured as a single source of truth in a manner that reduces artificial intelligence training bias caused by training on multiple copies of a traditional document.

20. A system comprising:
at least one physical processor;
physical memory comprising computer-executable instructions that, when executed by the physical processor, cause the physical processor to:
receive, at an electronic document executing on a physical processor, a request from a link to the electronic document;
process, by the electronic document, the request;
respond, by the electronic document, to the request by providing access to data of the electronic document.

21. The system of claim 20, wherein the link comprises an icon that is associated with the document.

22. The system of claim 20, wherein the link comprises a cover page for the electronic document that provides information about the electronic document.

23. The system of claim 22, wherein the cover page is encrypted.

24. The system of claim 20, wherein the link comprises a bookmark to a specific section of the document.

25. The system of claim 20, wherein the link comprises a scannable code.

26. The system of claim 20, wherein the link is configured to, when selected:
open a document viewer; and
open, within the document viewer, the electronic document.

27. The system of claim 20, wherein:
the computer-executable instructions cause the physical processor to process the request by determining that the request is from an entity authorized to access the electronic document; and
the computer-executable instructions cause the physical processor to respond to the request comprising providing the entity with access to the electronic document.

28. The system of claim 27, wherein the computer-executable instructions, when executed by the physical processor, further cause the physical processor to:
revoke an access right of the entity to the electronic document;
receive, at the electronic document, an additional request from the link to the electronic document;
determine, by the electronic document, that the additional request was initiated by the entity; and
deny, by the electronic document, access to the electronic document.

29. A non-transitory computer-readable medium comprising computer-executable instructions that, when executed by at least one of one or more processors of a computing device, cause the computing device to:
receive, at an electronic document executing on a physical processor, a request from a link to the electronic document;
process, by the electronic document, the request;
respond, by the electronic document, to the request by providing access to data of the electronic document.

30. The non-transitory computer-readable medium of claim 29, wherein the link comprises an icon that is associated with the document.

31. A computer-implemented method, comprising:
receiving, at an electronic document executing on a physical processor, an access request from an entry page configured to render at least a portion of the electronic document in a fixed-layout format of a legacy file type; and
responding, by the electronic document, to the request in a manner that a legacy document of the legacy file type is not capable of.

32. The computer-implemented method of claim 31, wherein the response to the request comprises extracting metadata from the electronic document via the entry page.

33. The computer-implemented method of claim 31, wherein the entry page comprises a cover page that provides information related to the electronic document.

34. The computer-implemented method of claim 31, wherein the entry page is encrypted.

35. The computer-implemented method of claim 31, wherein the response to the request comprises dynamically reformatting the electronic document for display on a plurality of device types.

36. The computer-implemented method of claim 31, wherein the response to the request further comprises verifying a digital signature associated with the electronic document prior to responding to the access request.

37. The computer-implemented method of claim 31, wherein the response to the request further comprises rendering an interactive user interface for accessing the electronic document.

38. The computer-implemented method of claim 31, wherein the response to the request further comprises authenticating a requesting entity using multi-factor authentication.

39. The computer-implemented method of claim 31, wherein processing the access request comprises comparing the requesting entity's credentials against access control rules stored in the electronic document.

40. The computer-implemented method of claim 31, wherein the response to the request comprises logging the access request and the corresponding response in an audit trail.

41. The computer-implemented method of claim 31, wherein the access request includes parameters specifying a predetermined section of the electronic document to be rendered.

42. The computer-implemented method of claim 31, wherein the response to the request comprises adapting the response based on limitations of the fixed-layout format of the legacy file type.

43. The computer-implemented method of claim 31, wherein the response to the request comprises converting the electronic document from the fixed-layout format to a dynamically rendered format responsive to user interaction.

44. The computer-implemented method of claim 31, wherein the response to the request comprises integrating with an external authentication service to validate the access request.

45. The computer-implemented method of claim 31, wherein processing the access request comprises determining that the request originates from an authorized domain.

46. The computer-implemented method of claim 31, wherein the response to the request comprises issuing a notification to an administrator upon receipt of an access request that does not meet predefined security criteria.

47. The computer-implemented method of claim 31, wherein responding to the access request comprises presenting additional contextual metadata associated with the electronic document.

48. The computer-implemented method of claim 31, wherein the response to the request comprises providing a user-selectable option to access a plurality of versions of the electronic document.

49. The computer-implemented method of claim 31, wherein processing the access request comprises verifying that the electronic document remains unaltered since the application of a digital signature.

50. The computer-implemented method of claim 31, wherein the response to the request comprises displaying a warning message if the access request is received outside of permitted time parameters.

51. The computer-implemented method of claim 31, wherein the response to the request comprises determining the geographic location of the requesting entity and restricting access based on location.

52. The computer-implemented method of claim 31, wherein the response to the request comprises rendering a customizable interface that adjusts based on user preferences stored in the electronic document.

53. The computer-implemented method of claim 31, wherein the response to the request comprises enabling concurrent access by multiple entities to different sections of the electronic document.

54. The computer-implemented method of claim 31, wherein the response to the request comprises responding to the access request by activating one or more embedded in-document applications.

55. The computer-implemented method of claim 31, wherein the response to the request comprises highlighting redacted sections of the electronic document when rendering the electronic document for an accessing entity.
